(19) United States
(12) Patent Application Publication
(10) Pub. No.: US 2016/0021728 A1
(43) Pub. Date: Jan. 21, 2016

(54) PLASMATRON AND HEATING DEVICES COMPRISING A PLASMATRON

(71) Applicant: HHO Heating Systems B.V., Waddinxveen (NL)

(72) Inventors: Lambertus Johannes Theodorus Van Veldhoven, Waddinxveen (NL); Richard Arie Nicolaas Wisse, Beverwijk (NL)

(73) Assignee: HHO Heating Systems B.V., Waddinxveen (NL)

(21) Appl. No.: 14/767,312

(22) PCT Filed: Feb. 25, 2014
(86) PCT No.: PCT/NL2014/000009

§ 371 Date: Aug. 12, 2015

(30) Foreign Application Priority Data
Feb. 27, 2013 (NL) 1040070

(51) Int. Cl. H05H 1/34; F24H 3/00

(52) U.S. Cl. CPC H05H 1/34; F24H 3/002

(57) ABSTRACT

A plasmatron for heating a gas, more specifically air, located in a heating space, includes a nozzle having a nozzle wall and a nozzle opening located in the nozzle wall, whereby a ratio of a maximum diameter of a cross-section of the nozzle opening with respect to a first length of the nozzle opening is higher than 2. The plasmatron includes a cathode, a space located between the cathode and the nozzle wall, and a channel for guiding water or a water-containing liquid in the direction of the space. A heating device further includes a connection for connecting the plasmatron to a water supply system.

### FIELD OF THE INVENTION

The invention relates to a plasmatron for heating a gas, more specifically air, located in a heating space, comprising a nozzle, the nozzle comprising a nozzle wall and a nozzle opening located in the nozzle wall. Furthermore, the invention relates to heating devices comprising a heating space and a plasmatron.

### BACKGROUND OF THE INVENTION

Heat sources of heating devices are generally based on combustion of a fuel, usually natural gas. Recently, an increasing amount of research has been focused on the use of alternative heat sources. In one disclosure of a heating device and in some disclosures of devices possibly able to function as a heat source for a heating device, use of a plasmatron plays a role.

A plasmatron is a device able to generate a plasma arc, which plasma arc extends from a cathode electrically connected to a voltage source. In a plasmatron generating a non-transferred plasma arc the plasma arc is generated in a space between the cathode and an anode that is part of the plasmatron, generally a nozzle wall. For creating and maintaining a plasma arc a high potential difference is essential. The plasma arc is visible due to the ionized molecules, forming the plasma. A plasmatron generally comprises channels for supplying plasma gas to the space between the cathode and the anode. As a consequence of the high potential difference the plasma gas in or near the plasma arc is transformed to a plasma, i.e. the ionized plasma gas molecules. Due to the subsequent supply of plasma gas, the volume of the plasma arc and consequently the temperatures in and around the plasma arc will increase. Conventionally, the plasma gas is argon or helium or hydrogen gas or a mixture of these gasses. The plasma gasses are stored in appropriate pressurized gas bottles. Many plasmatrons comprise separate, closed, water based, cooling systems to protect the cathode and other parts of the plasmatron from the high temperatures of the plasma. However, the water in the water based cooling systems is not contacted directly with the plasma arc. In yet other plasmatrons water vapor or water is guided, in the anode-to-cathode-direction, towards the plasma arc for producing high velocity steam, see US 2010/0252537. The plasmatron disclosed in this patent document generates a plasma arc using a plasma gas that is argon in stead of water vapor. The cross-section of the nozzle opening of a conventional plasmatrons generating a non-transferred plasma arc generally is circular having a diameter of 0.2-0.6 mm. This feature of the nozzle diameter allows the plasma arc to be focused and the heat to be concentrated. Plasmatrons are mainly used for welding or cutting metal objects. U.S. Pat. No. 5,360,495 discloses a plasmatron producing a wide, but still straight, plasma ‘bundle’ extending through a nozzle opening. The length of the nozzle opening is such that magnets can be positioned along the nozzle opening. The cross-section of the nozzle opening disclosed in this patent document is oblong so that the plasma arc can be manipulated by the magnets such that a wide plasma ‘bundle’ is created. This nozzle opening is designed to concentrate, rather than to disperse, the plasma arc to produce sharper cutting edges.

CA 1 242 000 discloses a device comprising a plasmatron for heating high volumes of air, which device may possibly function as heat source for a heating device. Herein the plasma arc extends in an oblong space defined by an electrode located near the rear part of the space and another electrode located near the front part of the space. The heat of the plasma arc is released and the plasmatron, and more specifically its cathode, is protected from possibly damaging high temperatures by guiding high quantities of air through this space. This document does not disclose which plasma gasses are used to be supplied to the plasma arc. It is likely that the conventional plasma gasses were used. Conventional plasma gasses are stored in gas bottles requiring significant safety measures. Therefore, a heating device using a device disclosed in this document, is not suitable to be used for a heating device for domestic use, for instance for heating a house. Besides the fact that storage of the conventional gasses is unsafe, the costs of the conventional plasma gasses per se can add up to the total costs. As a consequence, such heating device is unfavorable with respect to usage costs. Another disadvantage of such a system is that only high volumes of air can be heated. Therefore, this system can hardly be connected to an existing water piping system belonging to a heating device in a house. Yet another disadvantage is that such a plasmatron comprises two separate channel systems, one for water for cooling the device and one for the plasma gas for remaining the plasma arc and increasing the temperatures in and around the plasma arc. The production costs of the separate channel systems add up to the total production costs. Moreover, this document does not disclose an evaluation of the efficiency of the system. In other words, it does not disclose the potential usage costs for heating the high volumes of air. Therefore, it is unclear if such a heating device can compete with the conventional heating devices with respect to usage costs.

UA81989 discloses a steam generator comprising a plasmatron. This steam generator may possibly function as a heat source for a heating device. In this case, steam in stead of the plasma arc would present the heat source. Namely, in this steam generator cold water is guided along the plasma arc generated by a plasmatron with the principal goal to create water vapor or high velocity steam. The energy needed to convert the volumes of water to water vapor reduces the efficiency of the system. Another disadvantage is that relatively high quantities of condensation water need to be discarded. This document does not disclose the plasma gasses used. Therefore, it can be assumed that the conventional plasma gasses were used, for which the disadvantages mentioned above in relation to heating devices for domestic use are relevant.

DE3735341 discloses a heating device wherein the heat source is based on a plasmatron. The heating device comprises a separate water channel system wherein water is used as coolant but does not contact the plasma arc directly. It does comprise means for supplying water to the combustion space through which the plasma arc extends. According to the inventers of this patent mentioned above the water in the combustion space is converted into steam and thermally decomposed to form hydrogen gas. The hydrogen gas is subsequently combusted. This document does not disclose the plasma gasses used. Therefore, it can be assumed that the conventional plasma gasses were used, for which the disadvantages mentioned above in relation to heating devices for domestic use are relevant. In this document it is disclosed that the temperature in the combustion space can be as high as 1200° C. However, it is assumable that when a plasma arc is generated, the temperature will be many times higher, and can reach temperatures that result in material damage. Namely, the temperature in a plasma arc can be high as 8000° C. As the decomposition of water results in hydrogen gas and this hydrogen gas is combusted in the combustion space, it is assumable that the supply of water and/or water vapor does not have a substantial cooling effect. This document does not mention cooling measures to protect the heating device. Increasing the dimensions of the combustion space is no solution because it would decrease the concentration hydrogen gas for combustion. Moreover, this document does not disclose an evaluation of the efficiency of the heating device. Therefore, it is unclear if such a heating device can compete with conventional heating devices using natural gas with respect to usage costs.

Problems arising when designing a plasmatron for a heating device or for a heating device in combination with a plasmatron, are related to the temperature in different ways. It is essential that the high temperatures in and around the plasma arc do not result in damage to the heating device or the plasmatron itself. It is not preferred to increase the volume of heating space in the heating device because this will prevent the heating device being positioned at the same location as a conventional heating device. Therefore it is essential that the intensity of the plasma arc is controlled. However, the possibilities to manipulate the plasma arc are limited. Constraints that have to be accounted for are, the distance between cathode and anode being too large as a consequence of which it is more difficult to create and/or maintain a plasma arc, the limited possibilities for heat transfer inside and outside the plasmatron, the high amount of electrical energy required for creating and/or maintaining the plasma arc as a consequence of which the heating efficiency decreases, and the like. On one hand it should be guaranteed that the cooling capacity of the plasmatron is able to prevent material damage and an instable electric arc, and on the other hand it should be guaranteed that the ratio of heat generated and electrical energy used is as high as possible. Another problem, unrelated to temperature, is storage of plasma gasses as argon, helium and/or hydrogen gas conventionally used, which is unsafe.

Therefore, it is an object of the invention to provide a plasmatron or a heating device comprising a plasmatron, not using plasma gasses stored in a gas bottle. Furthermore, it is an object of the invention to provide a heating device presenting usage costs that are equal to or lower than the usage costs of the conventional heating devices using natural gas. Furthermore, it is an object of the invention to provide a heating device that is suitable for domestic use, for instance for heating houses, and can be produced cost effectively and can be connected to an existing water supply system.

### SUMMARY OF THE INVENTION

In order to achieve at least one of these goals, the invention provides a plasmatron for heating a gas, more specifically air, located in a heating space, comprising a nozzle, the nozzle comprising a nozzle wall and a nozzle opening located in the nozzle wall, wherein the ratio of the maximum diameter of the cross-section of the nozzle opening with respect to the first length of the nozzle opening is higher than 2.

In an embodiment of the invention the ratio mentioned above is in the range of 2-3. In yet another embodiment the ratio mentioned above is in the range of 3-4.

A main advantage of a plasmatron comprising a nozzle as described above, is that it can generate a highly divergent plasma arc. Because of this the dispersion of the heat generated by the plasma arc is increased, and fewer measures are required for using such a plasmatron in a heating device for domestic use. When using a conventional plasmatron the distance from the nozzle opening to the opposite wall section of the wall surrounding a heating space, should be relatively high, in order to prevent damage of this wall section. As a consequence of this large distance being required, using a conventional plasmatron in combination with a heating device for domestic use is not realistic. However, one advantage of the plasmatron according to the present invention is that the divergent plasma arc enables realistic dimensions of a heating space in a heating device for domestic use.

The term “length” as used herein with respect to the nozzle opening, is intended to encompass the average dimension of the nozzle opening, defined by a section of the nozzle wall, which dimension is parallel to the main direction in which the plasma arc extends through the nozzle opening.

The term “cross-section” as used herein with respect to the nozzle opening, is intended to encompass the cross-section transverse of the main direction in which the plasma arc extends through the nozzle opening.

In an exemplary embodiment of a plasmatron according to the invention, the thickness of the nozzle wall is substantially equal to the first length of the nozzle opening and does not exceed 3 mm.

As a result of the first length of the nozzle opening being relatively low compared to the cross sectional area of the nozzle opening, it is not expected that the plasma arc will extend through the nozzle opening and leaving the plasmatron as a focused bundle of radiation beams. Preferably, the first length is in the range of 1 tot 2 mm.

In an exemplary embodiment of a plasmatron according to the invention the nozzle opening has a non-circular cross-section.

It is found that a non-circular nozzle opening is advantageous for increasing the dispersion of the plasma arc, and subsequently the heat deriving from the plasma arc, in other words for broadening the plasma arc, and in addition for obtaining a stable plasma arc at the same time.

Preferably, the nozzle wall comprises a nozzle opening having an oblong cross-section, wherein a second length of the cross-section is at least 1.3 times higher than a width of the cross-section. Without wishing to be bound by a theory, the width can be adequate to maintain a plasma arc while the second length enables a plasma arc of which the dispersion is improved.

In another exemplary embodiment of a plasmatron according to the invention, the nozzle wall comprises a nozzle opening having an oblong cross-section, the cross-section of the nozzle opening having a second length in the range of 3-5 mm and a width in the range of 1-2.5 mm.

In yet another exemplary embodiment of a plasmatron according to the invention, it further comprises a cathode, a space located between the cathode and the nozzle wall, and a channel for guiding water or a water-containing liquid in the direction of the space.

An advantage of the use of water or a water-containing liquid for the plasmatron according to the invention is that during use of the plasmatron a fraction of the water or water-containing liquid guided through the channel in the direction of the space, is transferred into steam in close proximity to the plasma arc as a result of the heat generated by the plasma arc. The steam drives the plasma arc through the nozzle opening very powerfully. Because the plasma arc is able to extend in a large extent outside the plasmatron and for example into a heating space, the heat generated by the plasma arc can be exploited optimally, for example to heat the medium in a heating device. Another advantage of the steam is that due to the very high temperatures in and around the plasma arc the water molecules are decomposed to give hydrogen gas and oxygen gas. The hydrogen gas is used as plasma gas and the ionized hydrogen atoms created in the plasma arc increase the volume of the plasma arc and increase the temperatures in and around the plasma arc. Therefore, when using the plasmatron according to the present invention in a heating device, the use of conventional plasma gasses stored in gas bottles is not required and can be omitted. Another advantage of the steam driving the plasma arc through the nozzle opening, and as a result elongating and broadening the plasma arc, is that material damage to the cathode and the nozzle wall due to temperatures being too high can be prevented. Preferably, the channel extends, at least partially, through the plasmatron and ends in close proximity to the cathode.

Preferably, the cathode extends through the channel in a direction facing away from the nozzle opening.

The advantage of such a plasmatron is that the water or the water-containing liquid can be used for generating steam to make the plasma arc broader and more powerful, as well as for cooling the cathode. No separate systems for plasma gas and for cooling are required as a consequence of which the production costs of a heating device comprising such a plasmatron can be limited. As a result of the heat generated by the plasma arc, the water or the water-containing liquid is experiencing a vortex movement around the cathode which improves the cooling efficiency of the water or the water-containing liquid and protects the cathode. Preferably, the channel is tubular and the cathode is positioned concentric with respect to the channel for optimal cooling efficiency.

The term “cathode” as used herein is intended to encompass a part of the plasmatron forming one entity with respect to electrical conductivity and thermal conductivity. The cathode part generating a plasma arc in close proximity to the nozzle wall is a part of this entity.

In yet another exemplary embodiment of a plasmatron according to the invention it comprises a tubular part consisting of glass or quartz glass having an inner diameter higher than, or equal to, a maximum outer diameter of the cathode, wherein, in mounted state, the tubular part is inserted in the channel and the cathode is inserted in the tubular part, such that in a functioning state the water or water-containing liquid in the channel can move back and forth from inside the tubular part to an outer side of the tubular part.

The tubular part functions as an electrical isolation layer mainly surrounding the cathode and efficiently allows a constant electrical potential difference between the cathode and the part of the nozzle wall functioning as anode. The tubular part further results in a certain segmentation which is advantageous for cooling the cathode. The water or water-containing liquid in the tubular part is agitated as a consequence of the pressure increase due to the high temperatures and development of high velocity steam. This agitation can be a vortex movement. Due to the resulting ability of the water or water-containing liquid to absorb the heat of the cathode when present at the inner side of the tubular part, and to subsequently release this heat to the environment when present at the outer side of the tubular part, it can cool the cathode efficiently. Preferably the ability to cool the cathode is adequate to prevent material damage.

In yet another exemplary embodiment of a plasmatron according to the invention it comprises a liquid reservoir, which liquid reservoir is suitable for containing water or a water-containing liquid and is fluidly connected to the channel.

The liquid reservoir can be filled with demineralized water, tap water originating from the public water system or a mixture of water and another liquid, for instance an alcohol, and the like. Preferably tap water or demineralized water is used as liquid in the heating device because in that case no harmful vapors or substances will be released and consequently no safety measures will be required. The liquid reservoir may be connectable to a water supply system, possibly with interposition of a dosing system comprising valves, and the like. Preferably the plasmatron is configured such that its liquid usage is 30-1,000 ml/hr.

Furthermore, the invention provides a heating device comprising a heating space and a plasmatron according to the invention for heating a gas, more specifically air, which gas is located in the heating space.

In such a heating device the heat source is a plasma arc generated the plasmatron, which plasma arc is divergent such that the dimensions of the heating space can be such, that the heating device can be build easily into private houses or small scale industry.

In the case this heating device uses water or water vapor as plasma gas, in addition to the electrical energy consumed for generating and remaining the plasma arc simply introduction or supply of water or a water-containing liquid is required. Furthermore, no harmful substances will be released during operating of the heating device.

Moreover, the invention provides a heating device according to the invention comprising a heating space and a plasmatron, wherein the plasmatron comprises a cathode, a space located between the cathode and the nozzle wall, and a channel for guiding water or a comprises a cathode, a space located between the cathode and the nozzle wall, and a channel for guiding water or a water-containing liquid in the direction of the space, and the heating device further comprises connection means for connecting the plasmatron to a water supply system.

The advantage of such a heating device is that is can be designed such that water of a water supply system can be guided continuously in the direction of the space. Preferably the connection means comprise a dosing system, for example comprising valves, and the like, so that dosed passage of water is possible and supply of water is independent of the existing pressure in the water supply system. Preferably, the channel extends at least partially through the plasmatron and ends in close proximity to the cathode.

In an exemplary embodiment the connection means comprise a pressure regulator for creating a pressure in the channel, the pressure being in the range of 800 mbar-1300 mbar. The average pressure in a water supply system is about 3 bars. This pressure is too high and not suitable to create or at least maintain a stable plasma arc. In this case the pressure should be reduced. On the other hand, the average ambient pressure is too low for optimal function of the plasmatron. In this case the water or water-containing liquid source should be pressurized. The inventers have shown experimentally that a water pressure in a range from 800 mbar to 1300 mbar results in a stable plasma arc.

Preferably, the heating space of the heating device according to the invention is surrounded by a piping system enabling a liquid medium for example water to flow close to the heating space. Preferably, the piping system of the heat exchanger is connectable to an existing piping system of a heating device, for instance to an existing water piping system belonging to a conventional heating device guided through the rooms of a house.

A difference between the heating devices according to the invention and the devices disclosed in UA81989 and DE3735341, see above, is that in heating devices according to the invention the water is guided in the direction of the space between the cathode and the nozzle wall, and that the nozzle opening is relatively wide. Therefore, the steam developed is able to make the plasma arc wider. Subsequently, hydrogen gas will be developed and will be used as plasma gas to enhance the plasma arc. The channels in the devices disclosed in UA81989 and DE3735341, guiding the water in the direction of the heating space in which steam is developed, are not able to effect the intensity and shape of the plasma arc. Furthermore, hydrogen gas possibly developed is not present at a location in which it can be used as plasma gas.

In an exemplary embodiment of a heating device according to the invention the nozzle wall is configured to function, at least partially, as an anode and the heating device also comprises a voltage source, which voltage source, in a mounted state, is connectable to the cathode and is configured to provide a direct current of 160-190 Volt between the cathode and the part of the nozzle wall functioning as anode.

Preferably, the heating device comprises control means to maintain this direct current between 160 and 190 Volt. The electrical potential difference should be high enough to maintain a stable plasma arc but low enough to result in an efficient heating device using a minimal amount of electrical energy. In an exemplary embodiment of the invention, the current strength varies with a constant electrical potential difference being between 4 and 9 ampere. As an alternative, or in addition, it is possible that the heating device comprises control means for controlling the current strength. Therefore, the voltage source is able to function based on a constant current and a varying electrical potential difference, preferably between 160 and 190 Volt.

It is found that a plasmatron which comprises such a nozzle wall, generates a plasma arc that is highly dispersed, in other words more divergent compared to the plasma arc generated by a conventional plasmatron. Furthermore, the plasma arc remains stable and is able to protrude into the heating space in great extent.

Because of the fact that the nozzle opening is different from that of a conventional plasmatron, see above, more steam can be driven through the nozzle opening as a consequence of which the dispersion of the plasma arc, and consequently the heat resulting from it, is increased. Therefore, the heat transfer from the plasma arc to the medium in the heating space is improved. This is advantageous for enabling the plasmatron to efficiently heat the medium. However, it is also advantageous for preventing material damage as well as for designing a heating space having practical dimensions.

An unexpected advantage of a plasmatron according to the invention is that it consumes less electrical energy compared to a similar plasmatron comprising a conventional nozzle.

Possibly, the specific shape of the nozzle opening increases the electrical resistance between the cathode and part of the nozzle wall functioning as anode.

In an exemplary embodiment of a heating device according to the invention, the heating capacity is similar to that of a conventional heating device using natural gas. The inventors have found that, considering the recent price of natural gas, an exemplary embodiment of the heating device according to the present invention is more advantageous with respect to usage costs compared to a conventional heating device using natural gas. See also a description of this exemplary embodiment at the end of the section: Detailed description of the figures.

In an exemplary embodiment of a heating device according to the invention, the heating space is defined by a wall, which wall comprises at least one aperture, wherein a minimum dimension of a cross-section of the aperture is at least 2 times higher than a maximum dimension of a maximum cross-section of an end section of the plasmatron facing the aperture. This relatively wide aperture is advantageous for controlling the heat generated by the plasma arc.

In yet another exemplary embodiment of a heating device according to the invention, the plasmatron protrudes through the aperture in the wall defining the heating space such that it is mainly located outside the heating space and the nozzle opening is located in close proximity to the aperture.

It is preferred that the part of the plasmatron located outside the heating space comprises a large part of the cathode extending through the channel in a direction facing away from the nozzle opening, such that the heat deriving from the cathode and absorbed by the water or water-containing liquid can be subsequently released into the area outside the heating space due to the movement of the water or water-containing liquid back and fort from the inside the tubular part to the outside of the tubular part. The inventors have discovered that when the plasmatron is largely located in the heating space, the temperature in the plasmatron exceeds a threshold value, which is set in order to prevent material damage.

In an exemplary embodiment the nature of the heating space is such that one dimension of a cross-section of the heating space does not exceed 150 cm. It is preferred that one dimension of a cross-section of the heating space does not exceed 75 cm. As a result of the fact that the plasma arc of the plasmatron according to the invention is divergent and the heat can be dispersed adequately, it is possible that the heating space can have practical dimensions. It is due to the divergent shape of the plasma arc that the heat is less concentrated and the material of the heating space walls defining the heating space will not be exposed to excessive temperatures. The advantage of such a heating space is that the outer dimensions of the total heating device, in which the heating space is the most voluminous, is comparable to the outer dimensions of a conventional heating device using natural gas. Therefore the heating device according the present invention can replace the conventional heating device without difficulty.

### SHORT DESCRIPTION OF THE FIGURES

The invention shall now be described in more detail with reference to exemplary embodiments thereof as shown in the accompanying figures, in which:

FIG. 1 shows a schematic representation of a cross-section of a plasmatron of an exemplary embodiment of a heating device according to the invention;

FIG. 2 shows a schematic representation of a cross-section of an exemplary embodiment of a heating device according to the invention;

FIG. 3 shows a schematic representation of a top view of a nozzle wall of an exemplary embodiment of a heating device according to the invention, and

FIG. 4 shows schematic representation of a cross-section of a nozzle wall of an exemplary embodiment of a heating device according to the invention.

### DESCRIPTION OF AN EXEMPLARY EMBODIMENT OF THE INVENTION

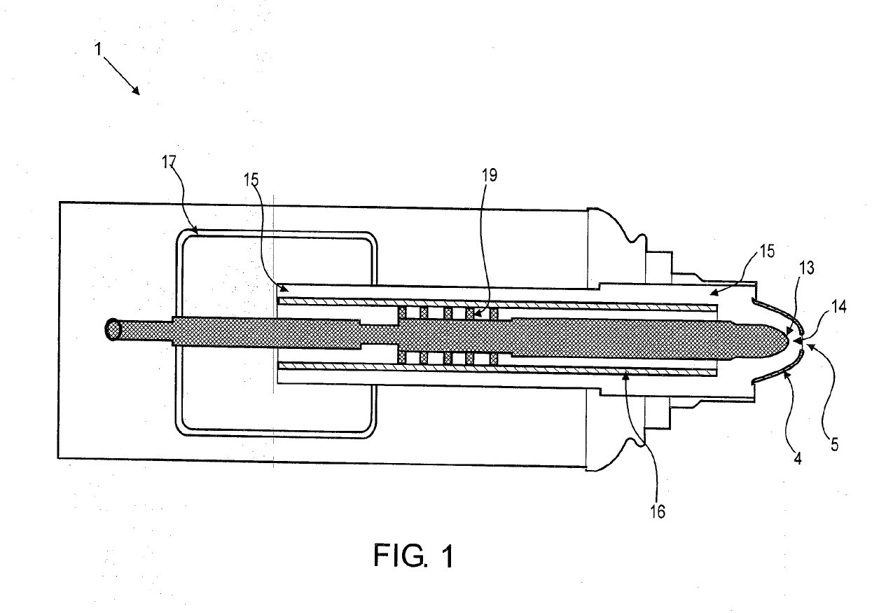

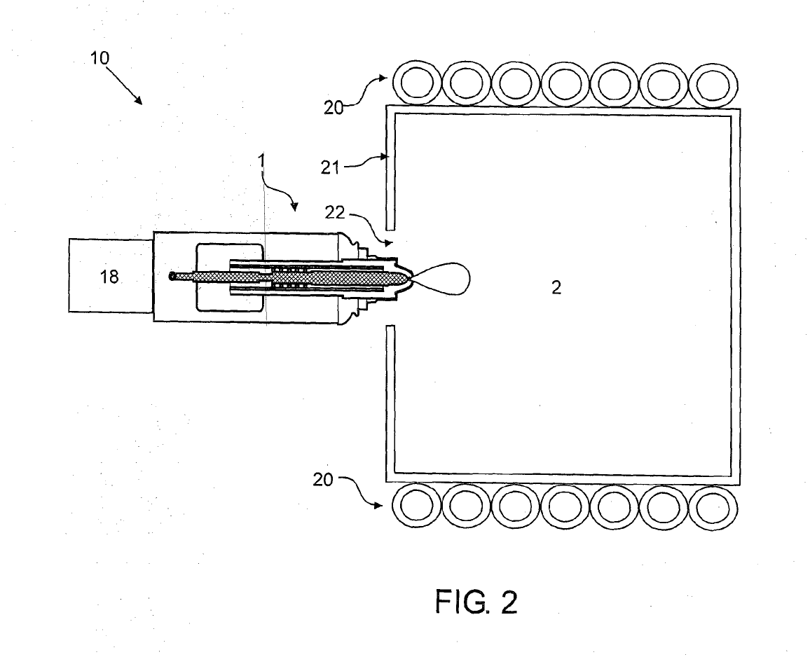

FIG. 1 shows a plasmatron (1) being the heat source of an exemplary embodiment of a heating device (10) according to the invention which is schematically shown in FIG. 2. The plasmatron (1) comprises a nozzle wall (4), a cathode (13) and a liquid reservoir (17). The cathode (13) is inserted concentrically in tubular part (16) consisting of glass or quartz glass, which tubular part (16) is subsequently inserted in the channel (15) present in the plasmatron (1). Water can be introduced into the channel (15). It is shown that the tubular part (16) is positioned with respect to the channel (15) and the cathode (13) such that water is allowed to be present between the cathode (13) and the tubular part (16) and between the tubular part (16) and the heating space wall of the plasmatron (1) defining the channel (15). The cathode is provided with connection means (19) for fixating the cathode with respect to the tubular part, which in this exemplary embodiment is a rubber sheath having protrusions. The arrow indicating the connection means (19) is pointing to these protrusions.

FIG. 2 shows the way the plasmatron (1) is positioned with respect to a heating space (2). Water, for example, can flow through water piping (20) surrounding the heating space (2). Preferably, the water piping (20) is connectable to an existing water supply system that can also be used in combination with a conventional heating device. It is shown that the plasma arc, which is represented very schematically, is driven into the heating space and is able to release its heat. The summary of the invention, see above, points out that the plasmatron according to the present invention generates a plasma arc that is divergent and that the heat generated by the plasma arc can be dispersed correspondingly. Therefore, material damage is prevented. In order to enable the water or water-containing liquid present in the channel (15) to cool the cathode (13) adequately, the part of the plasmatron, through which the cathode (13) and the tubular part (16) extend, is positioned outside the heating space (2).

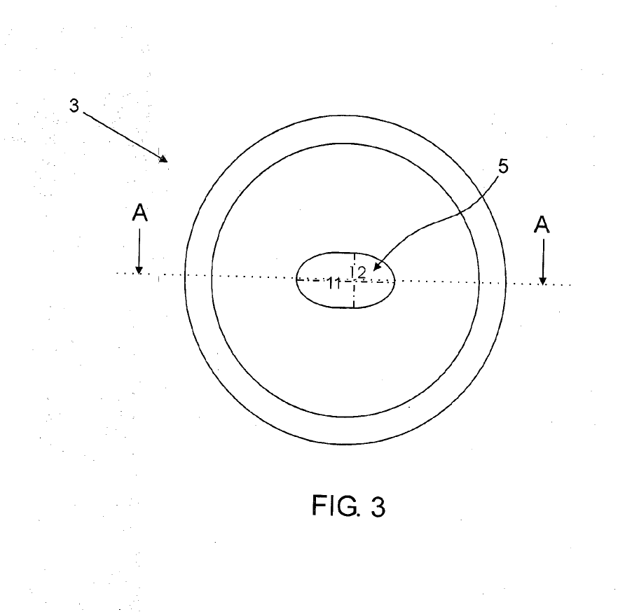

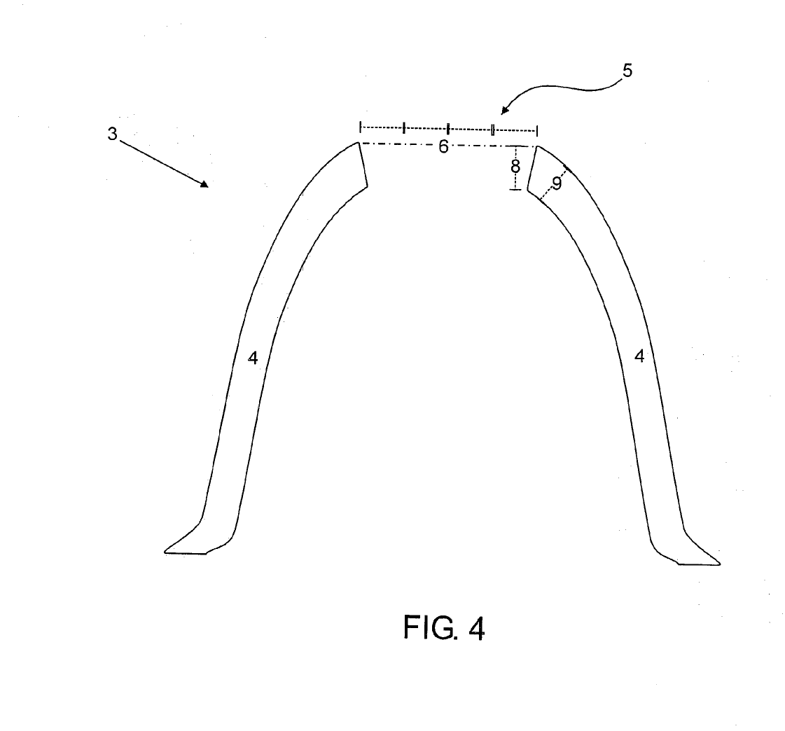

In FIGS. 3 and 4 an enlarged representation of the nozzle (3) is shown schematically. FIG. 3 shows a top view of the nozzle (3) showing the flattened edge, see also FIG. 2. FIG. 4 is a cross-section A-A of the nozzle wall (4) shown in FIG. 3, and enlarged. FIG. 3 shows that, for the nozzle (3) represented, the second length (11) of the cross-section of the nozzle opening (5) is about 1.7 times higher than the width (12) of the cross-section of the nozzle opening (5). FIG. 4 clearly shows that the ratio of the maximum diameter (6) of the cross-section of the nozzle opening (5) with respect to a first length (8) of the nozzle opening (5) is higher than 2. More specifically this ratio is about 4.

In a preferred exemplary embodiment of a heating device according to the invention the arrangement is as shown in FIG. 2, the plasmatron is as shown in FIG. 1 and the nozzle is as shown in FIGS. 3 and 4. When maintaining a direct current of 160-190 Volts, this exemplary embodiment is equal to a conventional heating device using natural gas with respect to its heating capacity. For this exemplary embodiment the electrical power required for a continuously running plasma arc, that is, when the heating device is “ON”, is in the range of 0.6 kW-1.7 kW. When considering the recent gas price, the usage costs of this exemplary embodiment are lower than a conventional heating device using natural gas. Besides the low usage costs also the production costs of such a heating device are very low.

1. A plasmatron for heating a gas, more specifically air, located in a heating space, comprising a nozzle, said nozzle comprising a nozzle wall and a nozzle opening in said nozzle wall, wherein a ratio of a maximum diameter of a cross-section of said nozzle opening with respect to a first length of said nozzle opening is higher than 2.

2. The plasmatron according to claim 1, wherein a thickness of said nozzle wall is substantially equal to said first length of said nozzle opening and does not exceed 3 mm.

3. The plasmatron according to claim 1, wherein said nozzle opening has a non-circular cross-section.

4. The plasmatron according to claim 3, wherein said nozzle opening has an oblong cross-section, wherein a second length of said cross-section is at least 1.3 times higher than a width of said cross-section.

5. The plasmatron according to claim 4, wherein said second length of said cross-section is in the range of 3-5 mm and said width of said cross-section is in the range of 1-2.5 mm.

6. The plasmatron according to claim 1, wherein it further comprises a cathode, a space located between said cathode and said nozzle wall, and a channel for guiding water or a water-containing liquid in the direction of said space.

7. The plasmatron according to claim 6, wherein said cathode extends through said channel in a direction facing away from said nozzle opening.

8. The plasmatron according to claim 1, wherein it further comprises a tubular part consisting of glass or quartz glass, said tubular part having an inner diameter higher than, or equal to, a maximum outer diameter of said cathode, and wherein, in a mounted state, said tubular part is inserted in said channel and said cathode is inserted in said tubular part such that, in a functioning state, said water or water-containing liquid in said channel can move back and forth from inside said tubular part to an outer side of said tubular part.

9. The plasmatron according to claim 1, wherein it comprises a liquid reservoir, which liquid reservoir is suitable for containing water or water-containing liquid and is fluidly connected to said channel.

10. A heating device comprising a heating space and a plasmatron according to claim 1, wherein said plasmatron is arranged for heating a gas, more specifically air, which air is located in said heating space.

11. A heating device comprising a heating space and a plasmatron according to claim 6, wherein said plasmatron is arranged for heating a gas, more specifically air, which air is located in said heating space, wherein said heating device comprises connection means for connecting said channel to a water supply system.

12. The heating device according to claim 11, wherein said connection means comprise a pressure regulator for creating a pressure in said channel, said pressure being in the range of 800 mbar-1300 mbar.

13. The heating device according to claim 12, wherein said nozzle wall is configured to function, at least partially, as an anode and in that said heating device further comprises a voltage source, which voltage source, in a mounted state, is connected to said cathode and is configured to provide a direct current of 160-190 Volt between said cathode and said part of said nozzle wall functioning as anode.

14. The heating device according to claim 13, wherein said heating space is defined by a wall which wall comprises at least one aperture, wherein a minimum dimension of a cross-section of said aperture is at least 2 times higher than a maximum dimension of a maximum cross-section of an end section of said plasmatron facing said aperture.

15. The heating device according to claim 14, wherein said plasmatron protrudes through said aperture in said wall defining said heating space, such that it is mainly located outside said heating space and said nozzle opening is located in close proximity to said aperture.

16. The heating device according to claim 15, wherein said heating space is shaped such that one dimension of a cross-section of said heating space does not exceed 150 cm.

17. The heating device according to claim 16, wherein said heating space is shaped such that one dimension of said cross-section of said heating space does not exceed 75 cm.
